(19) United States
(12) Patent Application Publication
(10) Pub. No.: US 2025/0368089 A1
(43) Pub. Date: Dec. 4, 2025

(54) REPLACEMENT SYSTEM FOR POWER STORAGE DEVICE

(71) Applicant: TOYOTA JIDOSHA KABUSHIKI KAISHA, Toyota-shi (JP)

(72) Inventors: Tsubasa MIGITA, Osaka (JP); Taro MATSUSHITA, Toyokawa-shi (JP); Yasuhiro KURODA, Toyota-shi (JP); Akio UOTANI, Nagoya-shi (JP); Shinji ICHIKAWA, Nagoya-shi (JP); Shuta ITO, Toyota-shi (JP)

(73) Assignee: TOYOTA JIDOSHA KABUSHIKI KAISHA, Toyota-shi (JP)

(21) Appl. No.: 19/037,284

(22) Filed: Jan. 27, 2025

(30) Foreign Application Priority Data
May 28, 2024 (JP) 2024-086243

(51) Int. Cl. B60L 53/80; B60L 53/62; H02J 7/00

(52) U.S. Cl. CPC B60L 53/80; B60L 53/62; H02J 7/0024; H02J 7/00712

(57) ABSTRACT

A power storage device replacement system includes a charging device and a replacement device. The replacement device is configured to replace a power storage device of the target vehicle. The target vehicle includes a plurality of the power storage devices and a first switching circuit. The first switching circuit is configured to be capable of switching between a series state in which the power storage devices are connected in series and a parallel state in which the power storage devices are connected in parallel. In the power storage device replacement system, when a first power storage device and a second power storage device mounted on the target vehicle are replaced with a third power storage device and a fourth power storage device, the charging device performs charging of at least one of the third power storage device and the fourth power storage device before the replacement.

### CROSS-REFERENCE TO RELATED APPLICATION

This application claims priority to Japanese Patent Application No. 2024-086243 filed on May 28, 2024, incorporated herein by reference in its entirety.

### BACKGROUND

### 1. Technical Field

The present disclosure relates to a replacement system for a power storage device.

### 2. Description of Related Art

Japanese Patent No. 6371450 indicates that the performance of the entire electrified vehicle driven by a plurality of batteries depends on the performance of a battery having the lowest remaining battery level. Japanese Patent No. 6371450 also indicates that a plurality of batteries stored in a battery station preferably has an equal remaining battery level when an electrified vehicle arrives. In a replacement system for a power storage device described in Japanese Patent No. 6371450, a supply amount of power to be supplied from one or more batteries loaded in a charger of a battery station to another battery is determined such that the remaining battery level (Ah) of the batteries approaches an equal value before an electrified vehicle arrives at the battery station. A management server transmits information about the supply amount to the battery station. The battery station controls charging of the batteries loaded in the charger based on the information received from the management server.

### SUMMARY

In the vehicle described in Japanese Patent No. 6371450, the performance of the entire vehicle depends on the performance of the power storage device having the lowest remaining battery level. Therefore, it is considered that a plurality of batteries (power storage devices) is connected in series in the vehicle. On the other hand, it is conceivable to provide a vehicle including a plurality of power storage devices with a switching circuit, in order to make it possible to change the voltage of a power storage unit of the vehicle according to the situation, for example. The switching circuit is configured to be capable of switching between a series state in which the power storage devices are connected in series and a parallel state in which the power storage devices are connected in parallel.

The replacement system for a power storage device described in Japanese Patent No. 6371450 provides a vehicle with a plurality of batteries having an equal remaining battery level (Ah). The relationship (voltage property) between the voltage (V) and the power storage amount (Ah) of the battery varies among batteries. When a plurality of power storage devices having an equal power storage amount are connected in parallel, there is a possibility that an instantaneous overcurrent is generated due to a voltage difference between the power storage devices. When the system described in Japanese Patent No. 6371450 is applied to the vehicle including the switching circuit, the switching circuit is likely to deteriorate due to an overcurrent at the time of parallel connection.

The present disclosure has been made to address the above issue. An object of the present disclosure is to provide a replacement system for a power storage device capable of suppressing an overcurrent at the time of parallel connection in a vehicle including a switching circuit capable of switching between series connection and parallel connection of a plurality of power storage devices.

An aspect of the present disclosure provides a replacement system for a power storage device to be described below.

The replacement system for a power storage device is
a system that replaces a power storage device, including
a charging device and a replacement device.
   The replacement device is configured to replace a power storage device of a target vehicle.
   The target vehicle includes
a plurality of power storage devices, and
a first switching circuit.
   The first switching circuit is configured to be capable of switching between a series state in which the power storage devices are connected in series and a parallel state in which the power storage devices are connected in parallel.
   In the replacement system for a power storage device, when the replacement device replaces a first power storage device and a second power storage device mounted on the target vehicle with a third power storage device and a fourth power storage device, the charging device executes charging of at least one of the third power storage device and the fourth power storage device so as to reduce a voltage difference between the third power storage device and the fourth power storage device before such replacement.

According to the above configuration, at least one of the third power storage device and the fourth power storage device is charged so as to reduce the voltage difference between the third power storage device and the fourth power storage device before the third power storage device and the fourth power storage device are attached to the target vehicle. This suppresses an overcurrent when the third power storage device and the fourth power storage device attached to the target vehicle are connected in parallel.

According to the present disclosure, it is possible to provide a replacement system for a power storage device capable of suppressing an overcurrent at the time of parallel connection in a vehicle including a switching circuit capable of switching between series connection and parallel connection of a plurality of power storage devices.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram illustrating a configuration (first switching circuit) of a vehicle according to an embodiment of the present disclosure;

FIG. 2 is a diagram illustrating a circuit configuration of each of the vehicle body and the battery pack according to the present embodiment;

FIG. 3 is a diagram illustrating an example of a configuration of a battery replacement system according to the present embodiment;

FIG. 4 is a diagram for describing a replacement request according to the present embodiment; and

FIG. 5 is a flowchart illustrating a battery replacement method according to the present embodiment.

### DETAILED DESCRIPTION OF EMBODIMENTS

An embodiment of the present disclosure will be described in detail with reference to the drawings. The same or corresponding parts in the drawings are designated by the same reference signs and repetitive description will be omitted.

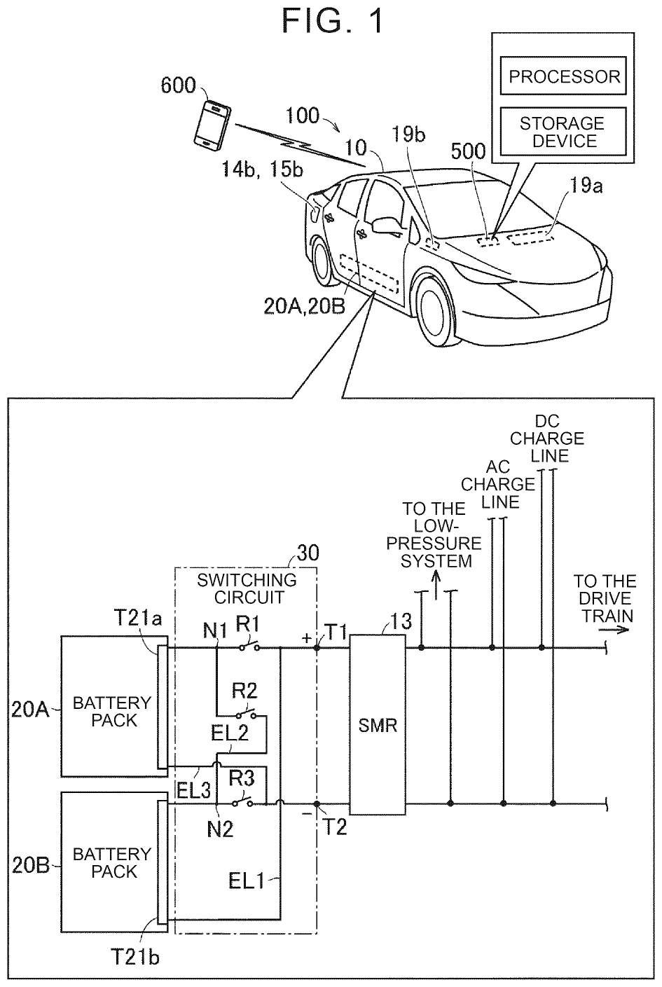

FIG. 1 is a diagram illustrating a configuration of a vehicle according to this embodiment. Referring to FIG. 1, a vehicle 100 includes a vehicle body 10 and battery-packs 20A, 20B. The vehicle body 10 is a part of the vehicle 100 other than the battery-packs 20A, 20B. The vehicles 100 are configured to be able to travel using the electric power stored in the battery-packs 20A, 20B. The vehicles 100 are, for example, battery electric vehicle (BEV without an internal combustion engine). However, the present disclosure is not limited thereto, and the vehicles 100 may be PHEV (plug-in hybrid electric vehicle) equipped with an internal combustion engine or other electrified vehicle (xEV).

The vehicle body 10 includes a switching circuit 30. The switching circuit 30 is configured to be able to switch between a series state in which the battery packs 20A, 20B are connected in series and a parallel state in which the battery packs 20A, 20B are connected in parallel. The switching circuit 30 includes three relays R1, R2, R3. The relay R1 is provided in an electric wire EL1 connecting the positive electrode terminal of the battery pack 20A and the positive electrode terminal of the battery pack 20B. The relay R2 is provided in an electric wire EL2 connecting the positive electrode terminal of the battery pack 20A and the negative electrode terminal of the battery pack 20B. The relay R3 is provided in an electric wire EL3 connecting the negative electrode terminal of the battery pack 20A and the negative electrode terminal of the battery pack 20B. The electric wire EL1 and the electric wire EL2 are connected to each other at a node N1. The electric wire EL2 and the electric wire EL3 are connected to each other at a node N2. The voltage of the battery packs 20A, 20B connected to each other is outputted between the terminal T1 (positive electrode terminal) and the terminal T2 (negative electrode terminal) via the switching circuit 30. Each of the terminals T1, T2 is provided in the electric wires EL1, EL3. The relay R1 is located between the terminal T1 and the node N1. The relay R3 is located between the terminal T2 and the node N2. When each of the relays R1, R2, R3 is OFF, ON, OFF, the battery-packs 20A, 20B are connected in series. When the relays R1, R2, R3 are ON, OFF, ON, the battery-packs 20A, 20B are connected in parallel. As a switching relay (relays R1, R2, R3) for switching between a series state and a parallel state, an electromagnetic-type mechanical relay can be adopted. Alternatively, however, a semiconductor relay may be used. The switching circuit 30 may switch between a series drive system (e.g., an 800 V drive system) and a parallel drive system (e.g., a 400 V drive system) that drives at a lower voltage than the series drive system. Hereinafter, in the vehicle 100, the battery-packs 20A, 20B in the series state and the battery-packs 20A, 20B in the parallel state may be referred to as a series state and a parallel state of the vehicle 100, respectively.

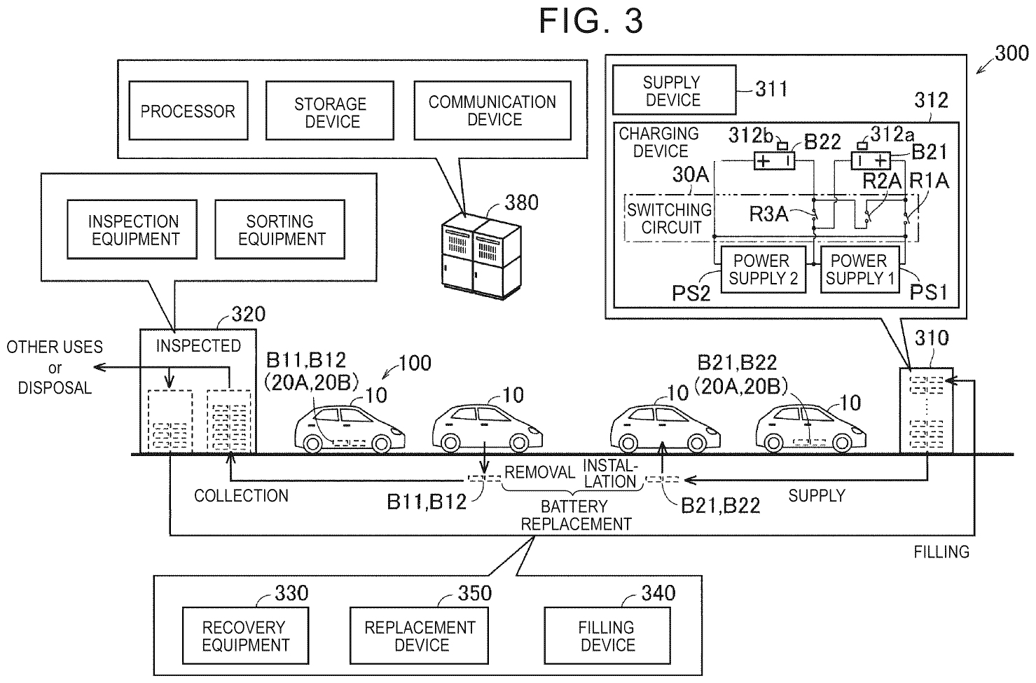

The vehicle body 10 further includes a Human Machine Interface (HMI) 19a and a communication device 19b. HMI 19a includes an inputting device and a displaying device. HMI 19a may include a touch panel display. The communication device 19b is configured to be capable of wirelessly communicating with each of the mobile terminal 600 and servers 380 (FIG. 3) described later.

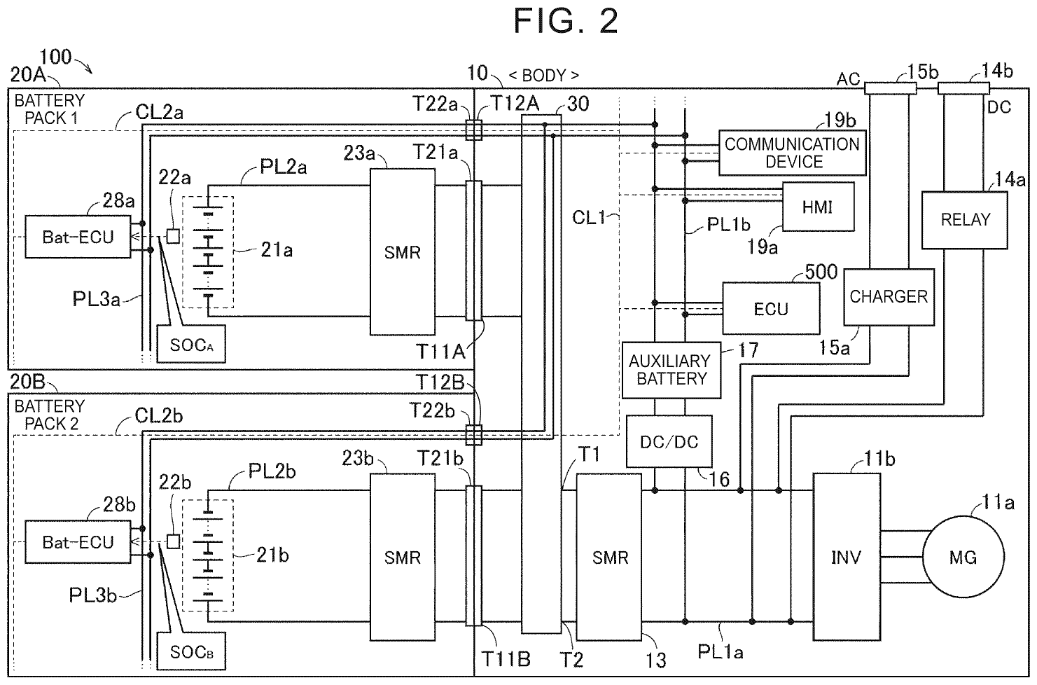

FIG. 2 is a diagram illustrating a circuit configuration of each of the vehicle body 10 and the battery-packs 20A, 20B. Referring to FIG. 2, the vehicle body 10 includes an SMR 13 and an ECU 500. The battery-pack 20A includes a battery 21a, a BMS 22a, an SMR 23a, an ECU 28a, electric wires PL2a, PL3a, a communication line CL2a, and terminals T21a, T22a. The battery-pack 20B includes a battery 21b, a BMS 22b, an SMR 23b, an ECU 28b, electric wires PL2b, PL3b, a communication line CL2b, and terminals T21b, T22b. “ECU” means Electronic Control Unit. “BMS” means Battery Management System. “SMR” means System Main Relay.

In the vehicle 100, ECU are communicably connected to each other via an in-vehicle network such as a Controller Area Network (CAN), for example. ECU includes a processor and a storage device. The storage device is configured to be able to save the stored information. In addition to the program, various kinds of information are stored in the storage device. In this embodiment, various kinds of control are executed by the processor executing a program stored in the storage device.

In this embodiment, since the battery packs 20A and 20B have the same configuration, they are referred to as “battery pack 20” when they are not distinguished from each other. Similarly, each of the batteries 21a, 21b may be referred to as “battery 21”, each of BMSs 22a, 22b as “BMS 22”, each of SMRs 23a, 23b as “SMR 23”, each of ECU 28a, 28b as “ECU 28”, each of the electric wires PL2a, PL2b as “electric wire PL2”, each of the electric wires PL3a, PL3b as “electric wire PL3”, each of the communication lines CL2a, CL2b as “communication line CL2”, each of the terminals T21a, T21b as “terminal T21”, and each of the terminals T22a, T22b as “terminal T22”.

In the battery-pack 20, the electric wires PL2, PL3 functions as a high-voltage power supply line and a low-voltage power supply line, respectively. The battery 21 applies a voltage to the electric wire PL2. The electric wire PL2 is connected to the terminal T21 via an SMR 23. SMR 23 switches the connection/disconnection between the batteries 21 and the terminal T21. Each of the electric wire PL3 (low-voltage power supply line) and the communication line CL2 (broken line in FIG. 2) is connected to the terminal T22. An ECU 28 is connected to each of the electric wire PL3 and the communication line CL2.

ECU 28 corresponds to a control device (Bat-ECU) that monitors the status of the batteries 21 and controls SMR 23. The battery 21 is, for example, a secondary battery such as a lithium ion battery, a nickel metal hydride battery, or a sodium ion battery. The type of the secondary battery may be a liquid secondary battery or an all-solid secondary battery. A plurality of secondary batteries may form a battery pack. BMS 22 detects the condition (current, voltage, temperature, etc.) of the battery 21, and outputs the detected condition to ECU 28. BMS 22 has a State Of Charge (SOC) measuring function, and outputs a measured value of SOC of the batteries 21 to ECU 28. SOC represents, for example, the ratio of the present amount of stored electricity to the amount of stored electricity in a fully charged state, in the range of 0% to 100%. As a method of measuring SOC, for example, a known method such as a current integration method or an OCV (open-circuit voltage) estimation method can be employed. Note that at least some of the functions of BMS 22 may be implemented in ECU 28. For example, BMS 22 may be a battery-monitoring unit. The battery monitoring unit transmits respective detected values (input values from the respective sensors) of the temperature, the current, and the voltage of the battery 21 to ECU 28. ECU 28 may determine SOC and State of Health (SOH) of the battery 21 from the voltage/current of the battery 21.

ECU 28a of the battery pack 20A transmits the measured value of SOC of the battery 21a acquired from BMS 22a (hereinafter, referred to as “SOC_{A}”) to ECU 500 as the information indicating SOC of the battery pack 20A. ECU 28b of the battery pack 20B transmits the measured value of SOC of the battery 21b acquired from BMS 22b (hereinafter, referred to as “SOC_{B}”) to ECU 500 as the information indicating SOC of the battery pack 20B. ECU 500 acquires information indicating the battery status (including SOC_{A}, SOC_{B}) from ECU (control device) of the respective battery packs.

The vehicle body 10 includes a vehicle driving device. Vehicle-driven devices include Motor Generator (MG) 11a and inverters 11b. MG 11a functions as a driving motor. The inverter 11b functions as a driving circuit of MG 11a. The inverter 11b drives MG 11a by using the electric power outputted from the battery packs 20A, 20B to the terminals T1, T2. MG 11a converts power to torques and rotates the drive wheels of the vehicles 100. MG 11a performs regenerative power generation at the time of deceleration of the vehicles 100, for example, and charges the battery-packs 20A, 20B.

The vehicle body 10 includes a charging system for external charging (charging by electric power supplied from the outside of the vehicle). The charging system includes a AC (AC) charging AC charger 15a and an AC inlet 15b, and a DC (DC) charging DC charging relay 14a and a DC inlet 14b. DC inlet 14b, AC inlet 15b is configured to be connectable to a DC power supply facility and a charge cable of AC power supply facility, respectively. Each of DC inlet 14b and AC inlet 15b provides a signal to ECU 500 indicating whether or not the charge cable is connected. DC charge-relay 14a is arranged in DC charge line connecting DC inlet 14b and the battery-packs 20A, 20B to switch the connection/disconnection of DC charge line. AC charger 15a is disposed in an AC charging line connecting AC inlet 15b and the battery-packs 20A, 20B, and performs power conversion (for example, AC/DC or switches conversion) between connection/disconnection of AC charging line. DC charge-relay 14a and AC charger 15a are controlled by ECU 500.

The vehicle body 10 includes an electric wire PL1a and a PL1b. The electric wires PL1a, PL1b function as a high voltage power supply line and a low voltage power supply line, respectively. SMR 13 is located between the electric wire PL1a and the terminals T1, T2, and switches between connection/disconnection of both. The electric wire PL1a (high voltage power supply line) is provided with an MG 11a, an inverter 11b, DC charge relay 14a, DC inlet 14b, AC charger 15a, and an AC inlet 15b. The vehicle body 10 further includes an auxiliary battery 17 that supplies electric power to auxiliary devices mounted on the vehicle 100. The auxiliary battery 17 applies a voltage lower than the voltage of the battery 21 to the electric wire PL1b. For example, an ECU 500, HMI 19a and a communication device 19b are connected to the electric wire PL1b (low-voltage power supply line). The vehicle body 10 further includes a DC/DC converter 16 that transforms DC power between the electric wire PL1a and the electric wire PL1b. The capacity of the auxiliary battery 17 is smaller than the capacity of the battery 21. When the amount of electric power stored in the auxiliary battery 17 decreases, DC/DC converters 16 step down the DC power from the electric wire PL1a and output it to the auxiliary battery 17.

The vehicle body 10 further includes terminals T11A, T12A to which the battery pack 20A is detachable, and terminals T11B, T12B to which the battery pack 20B is detachable. Each of the terminals T11A, T11B is connected to the electric wire PL1a via SMR 13 and the switching circuit 30. Each of the terminals T12A, T12B is connected to an electric wire PL1b (low-voltage power supply line) and a communication line CL1 (broken line in FIG. 2) in the vehicle body 10. Each of the terminals T21a, T22a of the battery-pack 20A is configured such that the vehicle body 10 is attachable and detachable. Each of the terminals T21b, T22b of the battery-pack 20B is configured to be detachable from the vehicle body 10. The terminals T21a, T22a are respectively connected to the terminals T11A, T12A, and the terminals T21b, T22b are respectively connected to the terminals T11B, T12B. As a result, the battery-packs 20A and 20B are attached to the vehicle body 10, and the vehicle 100 is completed. In the vehicle 100, the communication line CLI of the vehicle body 10, the communication line CL2a of the battery pack 20A, and the communication line CL2b of the battery pack 20B are connected. These communication lines constitute an in-vehicle network (e.g., a CAN) of the vehicles 100.

The battery packs 20A, 20B mounted on the vehicles 100 can be replaced with another battery pack. FIG. 3 is a diagram illustrating an example of a configuration of a battery replacement system for replacing a battery pack.

Referring to FIG. 3, the battery replacement system 300 is configured to remove a battery pack mounted on the vehicle 100 from the vehicle body 10 and attach another battery pack to the vehicle body 10. The battery replacement system 300 shown in FIG. 3 is installed in a replacement station. In this embodiment, the location where the exchange station is located corresponds to an example of a “predetermined area” according to the present disclosure.

The battery replacement system 300 includes a first storage device 310, a second storage device 320, a recovery device 330, a filling device 340, and an replacement device 350. The battery replacement system 300 further includes a server 380 that controls each of these devices. The server 380 includes a processor, a storage device, and a communication device. The storage device stores information related to each battery pack present in the battery replacement system 300 separately by the identification information of the battery pack. In this embodiment, the server 380 corresponds to an example of a “management device” according to the present disclosure.

In FIG. 3, the battery pack 20A and 20B are simultaneously removed from the vehicle 100, and two alternative battery packs are simultaneously attached to the vehicle 100. Hereinafter, the two battery packs collected from the vehicles 100 may be referred to as “battery packs B11, B12”. In addition, two battery packs attached to the vehicles 100 instead of the battery packs B11, B12 may be referred to as “battery packs B21, B22”. Each of the battery packs B11, B12, B21, B22 has the configuration of the battery pack shown in FIG. 2. The battery packs B21, B22 attached to the vehicle body 10 function as battery packs 20A, 20B (FIGS. 1 and 2) in the vehicle 100. Note that the battery-packs 20A, 20B may be replaced one by one, or only one may be replaced.

The first storage device 310 stores a plurality of battery packs to be supplied to the vehicle. The first storage device 310 includes a supply device 311 and a charging device 312 in addition to the pack storage unit. The charging device 312 includes power supplies PS1, PS2 and a switching circuit 30A. In the charging device 312, battery packs B21, B22 are set prior to being attached to the vehicle body 10, and BMS are provided for the respective battery packs. Specifically, BMSs 312a, 312b for detecting the status of the battery-packs B21, B22 are provided. Each of BMSs 312a, 312b includes a current sensor, a voltage sensor, and a temperature sensor, and has a SOC measuring function.

The switching circuit 30A is configured to be capable of switching between a series state in which the battery packs B21, B22 are connected in series and a parallel state in which the battery packs B21, B22 are connected in parallel. In this embodiment, the switching circuit 30A has the same configuration as the switching circuit 30 shown in FIG. 1. Specifically, the switching circuit 30A includes relays R1A, R2A, R3A. Each of the relays R1A, R2A, R3A has the same function as that of the relays R1, R2, R3. The charging device 312 can charge only one of the battery-packs B21, B22 or both simultaneously. Charging of the battery pack B21 or B22 means charging of the battery 21 in the battery pack B21 or B22, and SMR 23 in the battery pack B21 or B22 is maintained in the connected state (ON state) during charging. When both of the battery packs B21, B22 are charged simultaneously, SMR 23 of each of the battery packs B21, B22 are controlled to be connected.

The server 380 acquires, from BMSs 312a, 312b, information indicating the status of the battery-packs B21, B22 (for example, temperature/voltage, and SOC). The servers 380 may turn OFF, ON, OFF the relays R1A, R2A, R3A and charge the battery-packs B21, B22 in series by the power supply PS2. The servers 380 may turn ON, OFF, ON the relays R1A, R2A, R3A and charge the battery-packs B21, B22 in parallel by the power supplies PS1, PS2. The servers 380 may turn ON, OFF, OFF the relays R1A, R2A, R3A and charge the battery-pack B21 by the power supply PS1. The servers 380 may turn OFF, OFF, ON the relays R1A, R2A, R3A and charge the battery-pack B22 by the power supply PS2. In this embodiment, the switching circuit 30 and the switching circuit 30A correspond to exemplary “first switching circuit” and “second switching circuit”, respectively. The switching circuit 30 and the switching circuit 30A may be configured differently. The switching relay of the switching circuit 30A may have higher durability (for example, durability against overcurrent) than the switching relay of the switching circuit 30.

The second storage device 320 stores a plurality of battery packs collected from a plurality of vehicles. The second storage device 320 may include an inspection device and a sorting device in addition to the pack storage unit. For the battery-packs B11, B12 removed from the vehicle body 10, for example, as shown in FIG. 3, a reuse process is performed by the second storage device 320, the recovery device 330, and the filling device 340. Details of the replacement process by the battery replacement system 300 will be described later.

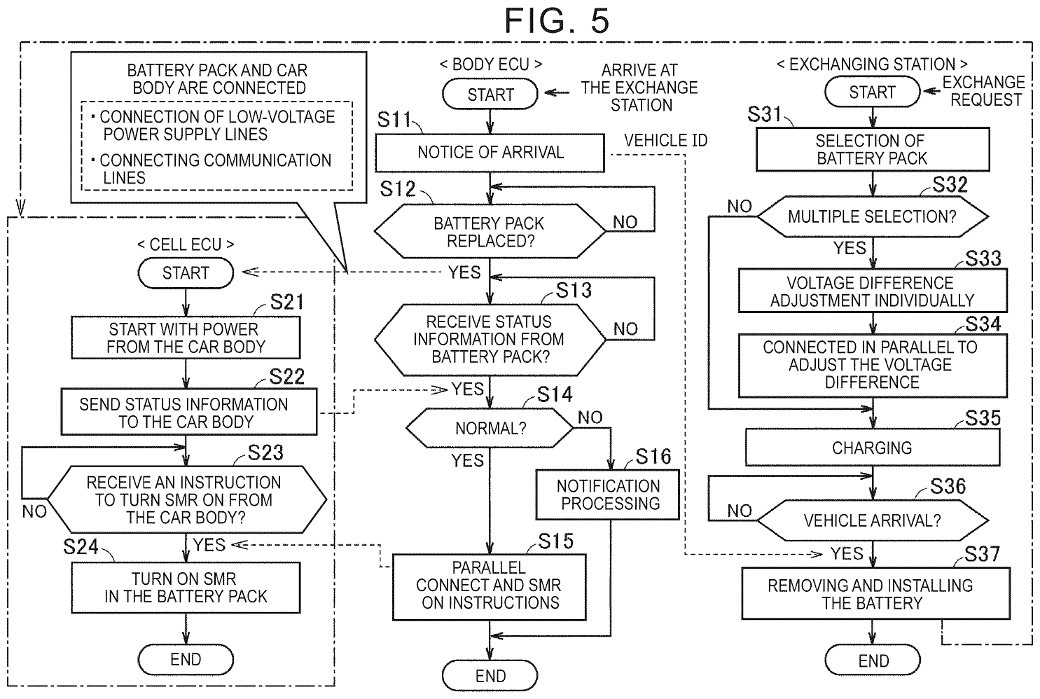

Upon receiving the exchange request from the user of the target vehicle, the server 380 starts a process flow (see FIG. 5 described later) for exchanging the power storage device of the target vehicle. The user of the target vehicle can send an exchange request to the server 380 by operating the user terminal. In this embodiment, the vehicle 100 corresponds to a target vehicle, and the mobile terminal 600 functions as a user terminal.

The mobile terminal 600 is, for example, a smartphone. A smartphone includes a computer and includes a touch panel display and a speaker. Application software for using a service provided by the server 380 is installed in the mobile terminal 600. However, the mobile terminal 600 is not limited to a smartphone, and may be a portable game machine or an electronic key, a wearable device, or a terminal embedded in a user (human body).

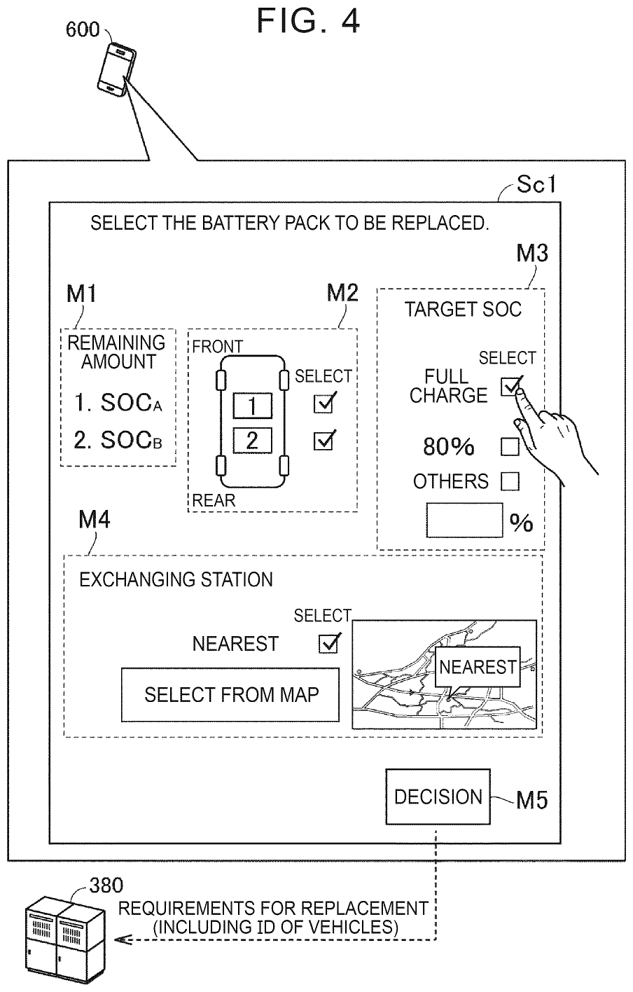

When the application software is activated, the mobile terminal 600 displays, for example, a display Sc1 illustrated in FIG. 4. FIG. 4 is a diagram for explaining an exchange request.

Referring to FIG. 4, the display Sc1 includes an information-unit M1 and operation units M2 to M5. The information unit M1 displays SOC (SOC_{A}) of the battery pack 20A and SOC (SOC_{B}) of the battery pack 20B. The operation unit M2 indicates each position of the battery packs 20A, 20B in the vehicle body 10, and accepts designation of a battery pack to be replaced. The information unit M1 and the operation unit M2 display information of the respective battery packs separately by the identification information (1, 2) of the battery packs. The operation unit M3 accepts designation of the target SOC. The user can specify the target SOC by selecting a target SOC from a predetermined option or inputting a numerical value indicating the target SOC. The operation unit M4 accepts designation of a replacement station. The user may designate the exchange station by choosing the exchange station closest to the current location of the vehicle 100 or by choosing another exchange station from among a plurality of exchange stations on the map. At least one battery pack is selected by the operation unit M2, a target SOC is designated by the operation unit M3, and a replacement station is designated by the operation unit M4. In this situation, when the user operates the operation unit M5 (for example, the enter button), the mobile terminal 600 sends an exchange request to the exchange station designated by the operation unit M4. In this embodiment, a replacement station including the battery replacement system 300 shown in FIG. 3 is designated by the user. Therefore, the exchange request is sent from the mobile terminal 600 to the server 380. The exchange request may be sent from the mobile terminal 600 to the server 380 via another server. The mobile terminal 600 transmits, together with the exchange request, information input by the user to the mobile terminal 600 (hereinafter, referred to as “user exchange information”) and identification information and specification information of the vehicle 100 (hereinafter, referred to as “target vehicle information”) to the server 380. The user-exchanged information indicates one or more battery packs selected by the operation unit M2 and a target SOC designated by the operation unit M3.

The mobile terminal 600 sends the exchange request to the server 380 before the target vehicle (vehicle 100) arrives at the exchange station. Upon receiving the replacement request, the server 380 starts the processes of S31 to S37 illustrated in FIG. 5. FIG. 5 is a flowchart illustrating a process according to the battery replacement method. “S” in the flowchart means step.

Referring to FIG. 5 together with FIG. 3, in S31, the server 380 selects the required number of battery packs corresponding to the specifications of the vehicle 100 from among the battery packs (stocks) held by the first storage device 310 based on the user-exchange information and the target vehicle information. The number of battery packs selected here corresponds to the number of battery packs (replacement number) indicated by the user exchange information. When selecting a plurality of battery packs, the server 380 may select the plurality of battery packs by using at least one of a capacity, a deterioration degree, and a voltage of each battery pack included in the candidate (inventory). The server 380 may preferentially select a plurality of battery packs having a capacity, a degree of degradation, or a voltage close to each other.

In the following S32, the servers 380 determine whether or not a plurality of battery packs have been selected in S31. For example, when the replacement request requests the replacement of the battery-pack 20A and 20B in the vehicle 100, it is determined as YES in S32, and the process proceeds to S33. Hereinafter, S31 in which battery-packs B21, B22 are selected will be described. The selected battery-packs B21, B22 are set in the charging device 312 by, for example, the supply device 311.

In S33, the servers 380 control the charging device 312 so that the voltage-difference between the battery pack B21 and the battery pack B22 becomes small. Specifically, the charging device 312 separately charges the battery pack B21 and the battery pack B22 such that the voltage differential of the battery packs B21, B22 measured by BMSs 312a, 312b is equal to or less than a predetermined reference value in accordance with an instruction from the server 380. SMR 23 in the battery-pack to be charged is controlled to be connected. The battery-packs B21, B22 are charged separately from each other. Each of the battery-packs B21, B22 has a tendency to increase in electric power as the amount of electric power stored increases.

In the following S34, the servers 380 control the charging device 312 so that the battery pack B21 and the battery pack B22 are in parallel. Specifically, the servers 380 connect SMR 23 of each of the battery-packs B21, B22. The server 380 connects the battery 21 in the battery pack B21 and the battery 21 in the battery pack B22 in parallel by turning ON, OFF, ON the relays R1A, R2A, R3A of the switching circuit 30A. As a result, the voltage is adjusted by exchanging electric power between the battery packs, and the voltage difference between the battery packs is further reduced. Since the individual charge (S33) is performed in advance, the overcurrent at the time of the parallel connection is suppressed.

In a subsequent S35, the servers 380 control the charging device 312 so that the battery-packs B21 and B22 in parallel are charged. Specifically, the charging device 312 charges the battery packs B21 and B22 in parallel until SOC of at least one of the battery packs B21 and B22 reaches a target SOC indicated by the user-exchange-information in accordance with an instruction from the servers 380. When one SOC of the battery-packs B21, B22 reaches the target SOC, even if the other SOC does not reach the target SOC, the servers 380 instruct the charging device 312 to terminate the charging. When the battery packs B21 and B22 are charged in parallel, it is possible to suppress an increase in the voltage differential between the battery pack B21 and the battery pack B22 during charging.

If the replacement request requires replacement of only one of the battery-packs 20A, 20B in the vehicle 100, S32 determines NO, and the process proceeds to S35 skipping S33 and S34. In this case, one battery pack selected by S31 is set in the charging device 312. Then, in S35, the set battery pack is independently charged. By this charge, SOC of the battery pack selected by S31 becomes the target SOC.

Subsequently, in S36, the servers 380 determine whether or not the target vehicle (vehicle 100) has arrived at the replacement station. The servers 380 wait for the target vehicles to arrive at S36.

When the vehicles 100 are parked in a predetermined position in the replacement station, ECU 500 starts S11 to S16 process flow. In S11, ECU 500 sends an arrival notification with the vehicle 100 identity (vehicle ID) to the servers 380. In the following S12, ECU 500 determines whether or not the battery-pack has been replaced. While the replacement of the batteries is not completed (NO in S12), the determination of S12 is repeatedly performed.

When the vehicle ID of the received arrival notification matches the vehicle ID of the exchange request (target vehicle information), the server 380 determines that the target vehicle has arrived at the exchange station. When charging (S35) by the charging device 312 is completed and the target vehicle arrives at the replacement station (YES in S36), the server 380 replaces, by S37, the battery pack designated by the user exchange information among the plurality of battery packs mounted on the target vehicle with the battery pack selected by S31. For example, when the battery packs 20A and 20B in the vehicles 100 are designated by the user exchange information, the battery packs 20A, 20B (battery packs B11, B12) are replaced as illustrated in FIG. 3. Specifically, the server 380 controls the replacement device 350 so that the battery-packs B11, B12 are removed from the vehicle body 10. Accordingly, the vehicle body 10 and the battery-packs B11, B12 are separated from each other. Subsequently, the server 380 controls the supply device 311 so that the battery-packs B21, B22 charged by the above-described S33 to S35 is conveyed (supplied) from the first storage device 310 to the replacement device 350. Subsequently, the servers 380 control the replacement device 350 so that the battery-packs B21 and B22 are attached to the vehicle body 10. At this time, each SMR 23 of the battery-packs B21, B22 is open. Thereafter, the server 380 transmits a signal indicating completion of the installation of the battery pack (hereinafter, referred to as a “replacement completion signal”) to ECU 500. Note that only one of the battery-packs 20A, 20B in the vehicle 100 is designated by the user-exchanged information. In this case, after one battery pack selected by S31 is attached to the vehicle body 10 instead of the battery pack 20A or 20B, the servers 380 transmit a replacement completion signal. After sending the replacement completion signal, the server 380 may charge the user of the vehicle 100 a fee corresponding to the target SOC.

FIG. 3 illustrates an example in which removal of the battery pack and attachment of the battery pack are performed at different positions. The vehicle position may be adjusted prior to removal of the battery pack, prior to installation of the battery pack, or both. A conveyance device (for example, a conveyance device of a conveyor type) or a conveyance robot (not shown) may move the vehicle. However, the removal of the battery pack and the attachment of the battery pack may be performed at the same position. The battery pack may be replaced (removed and attached) while the vehicle is stationary. The transport system of each of the supply device 311, the recovery device 330, and the filling device 340 is also optional. These conveyance methods may be a conveyor method or a method using a conveyance robot. The user may manually replace the battery pack (power storage device) instead of the replacement device 350.

At least one battery pack (hereinafter referred to as “replacement pack”) attached to the vehicle body 10 by S37 process has the same configuration as the battery pack 20A or 20B (FIGS. 1 and 2). By S37 process, the low-voltage power supply line and the communication line of the replacement pack are connected to the low-voltage power supply line and the communication line of the vehicle body 10, respectively. However, the high-voltage power supply line is interrupted by SMR 23 of the replacement pack. After S37 process, S21 to S24 process sequence is executed for each replacement pack.

In S21, ECU 28 of the replacement pack is activated by the electric power supplied from the power supply (auxiliary battery 17) in the vehicle body 10. Subsequently, in S22, the activated ECU 28 transmits information indicating the status of the replacement pack (hereinafter referred to as “status information”) to ECU 500. The state information indicates, for example, the present state (e.g., voltage and temperature) of the battery 21 detected by BMS 22. Subsequently, ECU 28 determines whether or not an SMR on-command has been received from the vehicle body 10 in S23. ECU 28 waits for an SMR on-command from the vehicle body 10 in S23 while keeping SMR 23 open.

On the other hand, ECU 500 receives the replacement completion signal from the servers 380 after S37 is processed. As a result, it is determined that S12 is YES, and the process proceeds to S13. S13 determines whether ECU 500 has received the status information from the replacement pack. Then, when ECU 500 receives the status information (YES in S13), ECU 500 determines whether or not the replacement puck is normal based on the status information in S14. If the replacement-pack is normal (YES in S14), ECU 500 sets SMR 13 to the connected state (ON state) and the switching relay of the switching circuit 30 to the parallel connected state (relay R1: ON, relay R2: OFF, and relay R3: ON) in S15. At the same time, SMR on-command is transmitted to the replacement pack. Thereafter, the processing flow ends. On the other hand, if an error has occurred in the replacement-pack (NO in S14), ECU 500 performs a predetermined notification process in S16, and then the process flow ends. In S16, ECU 500 may cause HMI 19a to execute the notification process. HMI 19a may notify the user that an anomaly has occurred, for example, by at least one of displaying, sounding (including audio), and lighting (including flashing).

In ECU 28 of the replacement pack, when SMR on command (S15) is received from the vehicle body 10 (YES by S23), S24 switches SMR 23 from the open state (shut-off state) to the closed state (connected state). As a result, the process flow ends. The replacement pack operates as a battery pack 20A or a 20B (FIGS. 1 and 2) through the above-described process flow. S24 process causes the batteries 21a and 21b mounted on the vehicles 100 to be in parallel. Thereafter, when the vehicles 100 begin running, ECU 500 may place the battery packs 20A and 20B (and thus the battery 21a and 21b) in series.

In the power storage device replacement system according to this embodiment, the replacement device 350 replaces the battery pack B11 (the first power storage device) and the battery pack B12 (the second power storage device) mounted on the target vehicle with the battery pack B21 (the third power storage device) and the battery pack B22 (the fourth power storage device). Prior to the replacement, the charging device 312 performs charging of at least one of the battery packs B21 and B22 so that the voltage-difference between the battery pack B21 and the battery pack B22 becomes small (S33). Therefore, an overcurrent is less likely to occur when the battery packs 20A and 20B (and thus the batteries 21a and 21b) are in parallel.

Note that the above-described functions of the server 380 may be realized by hardware (for example, an electronic circuit) alone or by using software. The functions of the server 380 may be divided into a plurality of units. For example, a function of controlling the charging device 312 and a function of communicating with a user terminal of a target vehicle to manage information may be implemented in separate units.

The server 380 illustrated in FIG. 3 is an on-premises server. However, the management device may be at least one computer on the cloud. For example, the functions of the server 380 may be implemented on the cloud. An HMI 19a (in-vehicle HMI) may be adopted as the user terminal instead of the mobile terminal 600.

The processing flow illustrated in FIG. 5 can be changed as appropriate. For example, the order of processing may be changed, or unnecessary steps may be omitted, depending on the purpose. Further, the content of any of the processes may be changed. For example, one of S33, S34 may be omitted.

The configuration of the vehicle is not limited to the above-described configuration (see FIG. 2). For example, one of SMRs 13, 23 may be omitted. Also, all of SMRs 13, 23a, 23b may be omitted. The vehicle may include three or more power storage devices (e.g., a detachable battery pack). The vehicle is not limited to a passenger car, and may be a bus or a truck. The vehicle may be configured to be contactless chargeable. The vehicle may comprise a solar panel. The vehicle may be configured to be capable of autonomous driving, or may be configured to be capable of traveling unmanned.

The embodiment disclosed herein shall be construed as exemplary and not restrictive in all respects. The scope of the present disclosure is shown by the claims rather than by the above description of the embodiments, and is intended to include all modifications within the meaning and scope equivalent to those of the claims.

What is claimed is:

1. A system that replaces a power storage device, wherein:
the system includes a charging device and a replacement device;
the replacement device is configured to replace a power storage device of a target vehicle;
the target vehicle includes
a plurality of power storage devices, and
a first switching circuit configured to be capable of switching between a series state in which the power storage devices are connected in series and a parallel state in which the power storage devices are connected in parallel; and
when the replacement device replaces a first power storage device and a second power storage device mounted on the target vehicle with a third power storage device and a fourth power storage device, the charging device executes charging of at least one of the third power storage device and the fourth power storage device so as to reduce a voltage difference between the third power storage device and the fourth power storage device before such replacement.

2. The replacement system for a power storage device according to claim 1, wherein:
the charging device includes a second switching circuit configured to be capable of switching between a series state in which the third power storage device and the fourth power storage device are connected in series and a parallel state in which the third power storage device and the fourth power storage device are connected in parallel;
the charging device executes charging of the third power storage device and the fourth power storage device with the third power storage device and the fourth power storage device brought into the parallel state; and
the replacement device replaces the first power storage device and the second power storage device in the target vehicle with the third power storage device and the fourth power storage device after the charging by the charging device is completed.

3. The replacement system for a power storage device according to claim 2, wherein when the replacement device replaces the first power storage device and the second power storage device with the third power storage device and the fourth power storage device, the target vehicle brings the third power storage device and the fourth power storage device into the parallel state.

4. The replacement system for a power storage device according to claim 1, further comprising a management device, wherein:
the charging device and the replacement device are installed in a predetermined area;
the management device is configured to receive a replacement request from a user of the target vehicle before the target vehicle arrives at the predetermined area; and
the management device instructs the charging device to perform charging so as to reduce the voltage difference between the third power storage device and the fourth power storage device after receiving the replacement request requesting replacement of the first power storage device and the second power storage device in the target vehicle.

5. The replacement system for a power storage device according to claim 4, wherein:
the replacement request indicates a target state of charge (SOC); and
the management device instructs the charging device to finish the charging when the voltage difference between the third power storage device and the fourth power storage device becomes equal to or less than a reference value and an SOC of at least one of the third power storage device and the fourth power storage device reaches the target SOC.
